(19) United States
(12) Patent Application Publication
(10) Pub. No.: US 2012/0057011 A1
(43) Pub. Date: Mar. 8, 2012

(54) FINGER VEIN RECOGNITION SYSTEM AND METHOD

(76) Inventors: Shi-Jinn Horng, Taipei City (TW); Shih-Wei Lai, Taipei City (TW)

(21) Appl. No.: 13/115,394

(22) Filed: May 25, 2011

(30) Foreign Application Priority Data
Sep. 3, 2010 (TW) 099129783

(51) Int. Cl. G06K 9/46; H04N 7/18

(52) U.S. Cl. 348/77; 382/124; 348/E07.085

(57) ABSTRACT

The present invention discloses a finger vein recognition system comprising an image catching module, an image preprocess module, a feature points calculating module, a feature database, a first comparing module and a second comparing module. The feature points calculating module is connected to the image preprocess module for calculating a set of distances among a plurality of feature points. The first comparing module is connected to the feature points calculating module and the feature database for comparing the set of distances and generating a compared result of feature points. The second comparing module is connected to the image preprocess module, the feature database and the first comparing module for catching a set of vein shape and comparing the set of vein shape with the feature database for generating a compared result of shape similarity. Wherein, the second comparing module combines the compared result of feature points and the compared result of shape similarity for generating a recognized result of the finger vein.

### CROSS-REFERENCE TO RELATED APPLICATION

This application claims priority based on Taiwanese Patent Application No. 099129783, filed on Sep. 3, 2010, the disclosure of which is incorporated herein by reference in its entirety.

### BACKGROUND OF THE INVENTION

1. Field of the Invention

This invention relates to a finger vein recognition system and method, and more particularly, to a finger vein recognition system and method combined with a feature point distance and a vein shape.

2. Description of the Prior Art

The term of technology has become indispensable to modern, there are always full of technologic products around people, and more technologic products have come out, such as personal digital assistants (PDA), smart phone, notebook computer, financial cards, electronic purse, and internet banking, etc. A lot of conveniences are created for human life by the technologic products, but it also brings security concerns.

In general, if a user needs to identity authentication, the conventional technologic product mostly uses a card with a password to achieve the recognition. But for most people, this approach is not sufficiently safe and often causes problems. For example, when the user loses the card or forgets the password, it will cause great inconvenience. Especially when a credit card is lost, there is not an effective mechanism to prevent the credit card fraud, and the damage cannot be underestimated.

Recently, due to the technology progress accompanied with the increase of the computing speed, there are more and more proposed methods. And the biometric identification is most widely used in the prior art, such as the early fingerprint recognition, voice recognition, face recognition, iris recognition, etc. The proposed methods have been widely applied for enhancing the convenience of human life and safety.

However, in recent years, the shortcomings and the fake of the conventional biometric identification method have been gradually put forward. For fingerprint recognition, it is impossible for everyone to rely on the fingerprint to identify the identification. According to statistics, the fingerprints of 7% people are not obvious by suffering from hyperhidrosis or dry hand symptoms. For face recognition, it cannot effectively distinguish whether the current identification of the object is alive. There is a possibility if the face image of the person is copied to fake. In addition, the conventional face recognition is influenced by the light, angle and other external environmental impact. For iris recognition, there are concerns on the eye security for the most people.

Compared to the prior art, the vein recognition is proposed and widely used in the biometric identification area. The vein recognition utilizes infrared rays to radiate palm or fingers, and recognizes by the biological characteristics of the vein. In general, the palm vein, the finger vein, and the wrist part of the dorsal hand vein are applied to be the identification of the subject matter, but the palm vein or the vein is the mainstream. However, due to the small size of the finger vein, the captured feature points are less. Therefore, how to increase the recognition rate with the less feature points is a major challenge to the field of finger vein recognition.

### SUMMARY OF THE INVENTION

One scope of the present invention is to provide a finger vein recognition system, comprising a image catching module, a image preprocess module, a feature points calculating module, a feature database, a first comparing module and a second comparing module. The image catching module is for catching a finger vein image. The image preprocess module is connected to the image catching module for preprocessing the finger vein image in accordance with a preset program. The feature points calculating module is connected to the image preprocess module for catching a plurality of feature points from the preprocessed finger vein image, and calculating a set of distances among the plurality of feature points. The feature database is for pre-storing a set of feature data. The first comparing module is connected to the feature points calculating module and the feature database for comparing the set of distances and generating a compared result of feature point distances. The second comparing module is connected to the image preprocess module, the feature database and the first comparing module for catching a set of vein shape and comparing the set of vein shape with the feature database for generating a compared result of shape similarity, wherein the second comparing module combines the compared result of feature point distance and the compared result of shape similarity for generating a recognized result of the finger vein.

Compared to the prior art, the finger vein recognition system of the present invention utilizes the first comparing module for generating the compared result of feature point distances, and utilizes the second comparing module for generating the compared result of shape similarity, and combines the compared result of feature point distances and the compared result of shape similarity for generating the recognized result of the finger vein. Due to the finger vein recognition system of the present invention providing with the advantage of a comparison of feature point distances for resisting a problem of the image rotation and the image translation. And a shape similarity of the finger vein is used for compensating a problem of the recognized effect relating to the feature points caught for calculating the feature point distances, the finger vein recognition system can work effectively regardless of a low quality image or a low-cost equipment. Compared to the prior art, the finger vein recognition system of the present invention has the advantage of a higher recognition rate with a lower cost.

Another scope of the present invention is to provide a finger vein recognition method comprising: (S1) catching a finger vein image; (S2) preprocessing the finger vein image; (S3) catching a plurality of feature points from the preprocessed finger vein image, and calculating a set of distances among the plurality of feature points; (S4) processing a first comparison for the set of distances with a feature database, and generating a compared result of feature point distances; (S5) catching a set of vein shape from the preprocessed finger vein image, processing a second comparison for the set of vein shape with the feature database, generating a compared result of shape similarity, combining the compared result of feature point distances and the compared result of shape similarity, and generating a recognized result of the finger vein.

Compared to the prior art, the finger vein recognition method of the present invention utilizes the compared result of feature point distances generated by the first comparison of (S4), and utilizes the compared result of shape similarity generated by the second comparison of (S5), and combines the compared result of feature point distances and the compared result of shape similarity for generating the recognized result of the finger vein. Due to the finger vein recognition method of the present invention providing with the advantage of a comparison of feature point distances for resisting a problem of the image rotation and the image translation. And a shape similarity of the finger vein is used for compensating a problem relating to the feature points caught for calculating the feature point distances, the finger vein recognition method can work effectively regardless of a low quality image or a low-cost equipment. Compared to the prior art, the finger vein recognition method of the present invention has the advantage of a higher recognition rate with a lower cost.

On the advantages and the spirit of the invention, it can be understood further by the following invention descriptions and attached drawings.

### BRIEF DESCRIPTION OF THE APPENDED DRAWINGS

FIG. 1 is a function block diagram of a finger vein recognition system of one embodiment of the invention.

FIG. 2 is a flow diagram of a predetermined procedure of one embodiment of the invention.

FIG. 3(A) to FIG. 3(E) are schematic diagrams of a series of the preprocessed finger vein images of one embodiment of the invention.

FIG. 4 is a schematic diagram of a vein shape of a finger vein image of one embodiment of the invention.

FIG. 5 is a schematic diagram of False Accept Rate (FAR) and False Reject Rate (FRR) for a finger vein recognition system of one embodiment of the present invention.

FIG. 6 is a flow diagram of a finger vein recognition method of one embodiment of the invention.

### DETAILED DESCRIPTION OF THE INVENTION

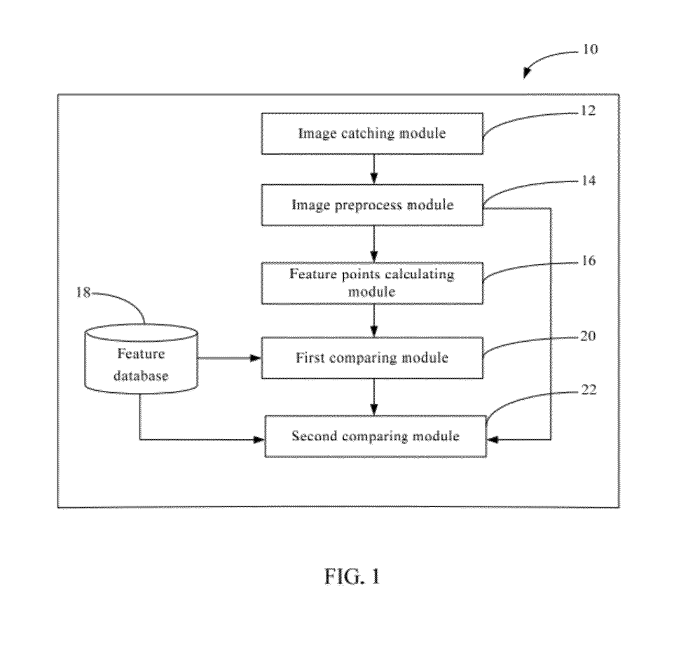

Please refer to FIG. 1. FIG. 1 is a function block diagram of a finger vein recognition system of one embodiment of the invention. The present invention provides a finger vein recognition system 10 comprising a image catching module 12, a image preprocess module 14, a feature points calculating module 16, a feature database 18, a first comparing module 20 and a second comparing module 22.

The image catching module 12 is used to catch a finger vein image. In actual practice, the image catching module 12 can comprise an infrared light source, a finger holder and a general Webcam.

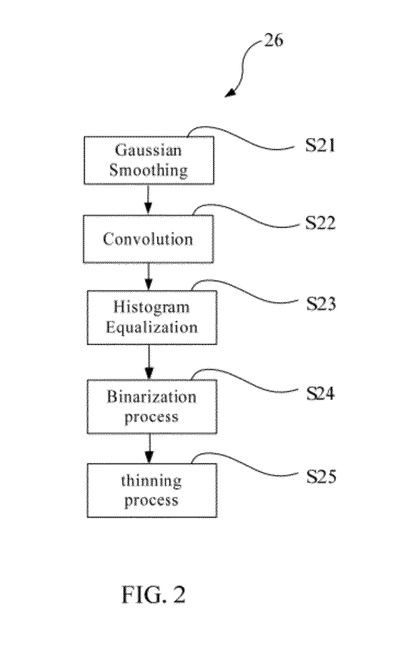

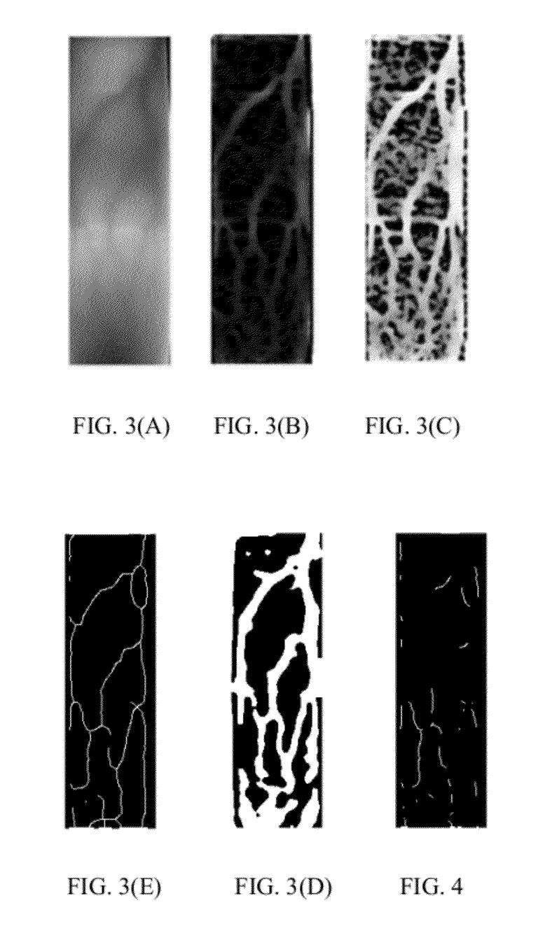

Please refer to FIG. 2 and FIG. 3(A) to FIG. 3(E). FIG. 2 is a flow diagram of a predetermined procedure of one embodiment of the invention. FIG. 3(A) to FIG. 3(E) are schematic diagrams of a series of the preprocessed finger vein images one embodiment of the invention. The image preprocess module 14 is connected to the image catching module 12 for preprocessing the finger vein image in accordance with a predetermined procedure 26, wherein the predetermined procedure 26 comprises: (S21) processing the finger vein image for a Gaussian Smoothing (as shown in FIG. 3(A)); (S22) processing the finger vein image processed by the Gaussian Smoothing for a Convolution (as shown in FIG. 3(B)); (S23) processing the finger vein image processed by the Convolution for a Histogram Equalization (as shown in FIG. 3(C)); (S24) processing the finger vein image processed by the Histogram Equalization for a Binarization process (as shown in FIG. 3(D)); (S25) processing the finger vein image processed by the Binarization process for a thinning process (as shown in FIG. 3(E)).

The feature points calculating module 16 is connected to the image preprocess module 14 for catching a plurality of feature points from the finger vein image processed by the thinning process (as shown in FIG. 3(E)), and calculating a set of distances among the plurality of feature points. Wherein, the plurality of feature points can be a plurality of branch points or edge points of the finger vein image processed by the thinning process.

The feature database 18 is used to pre-store a set of feature data.

The first comparing module 20 is connected to the feature points calculating module 16 and the feature database 18 for comparing the set of distances in accordance with the set of feature data and generating a compared result of feature point distances.

Please refer to FIG. 4. FIG. 4 is a schematic diagram of a vein shape of a finger vein image of one embodiment of the invention. The second comparing module 22 is connected to the image preprocess module 14, the feature database 18 and the first comparing module 20 for catching a set of vein shape from the preprocessed finger vein image, and comparing the set of vein shape with the feature database for generating a compared result of shape similarity. Wherein the set of vein shape (as shown in FIG. 4) is defined by subtracting the finger vein image processed by the Binarization process (as shown in FIG. 3(D)) from the finger vein image processed by the thinning process (as shown in FIG. 3(E)). Furthermore, the second comparing module 22 combines the compared result of feature point distances and the compared result of shape similarity for generating a recognized result of the finger vein. In the practical application, the second comparing module 22 can generate a score for the compared result of feature point distances and the compared result of shape similarity respectively, and combines the compared result of feature point distances and the compared result of shape similarity in a certain proportion for getting a recognized score. The recognition will be completed when the recognized score is higher than a pre-set score, otherwise, the recognition will be failed.

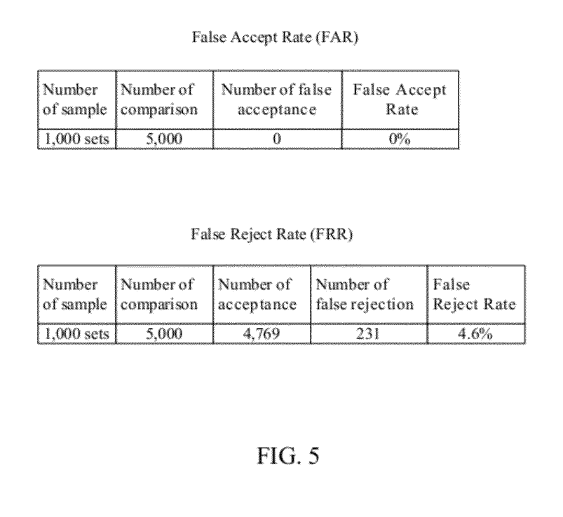

Please refer to FIG. 5. FIG. 5 is a schematic diagram of False Accept Rate (FAR) and False Reject Rate (FRR) for a finger vein recognition system of one embodiment of the present invention. In the practical application, False Accept Rate (FAR) and False Reject Rate (FRR) are used for the purpose of testing and quantifying the accuracy of the finger vein recognition system 10. For the finger vein samples from the fingers of 1,000 people, the feature database 18 was constructed by catching 5 vein images of one finger of each person. The FAR is got by choosing a set from the 1,000 sets of finger vein images in random for intrusion test, and eliminating the set of finger vein images from the feature database, and further utilizing the 5 finger vein images of the set of finger vein images for comparing each of the other 999 sets of finger vein images. The FRR is got by choosing a finger vein image from the 5 finger vein images of each set in random for comparing recognition. The result of recognition of the finger vein recognition system 10 is shown in FIG. 5.

Compared to the prior art, the finger vein recognition system 10 utilizes the first comparing module 20 for generating the compared result of feature point distances, and utilizes the second comparing module 22 for generating the compared result of shape similarity, and combines the compared result of feature point distances and the compared result of shape similarity for generating the recognized result of the finger vein. Due to the finger vein recognition system 10 providing the advantage of a comparison of feature point distances for resisting a problem of the image rotation and the image translation, and utilizes a shape similarity of the finger vein for compensating a problem of the recognized effect relating to feature points catching at calculating the feature point distances, the finger vein recognition system can work effectively regardless of a low quality image or a low-cost equipment. Compared to the prior art, the finger vein recognition system 10 has the advantage of a higher recognition rate with a lower cost.

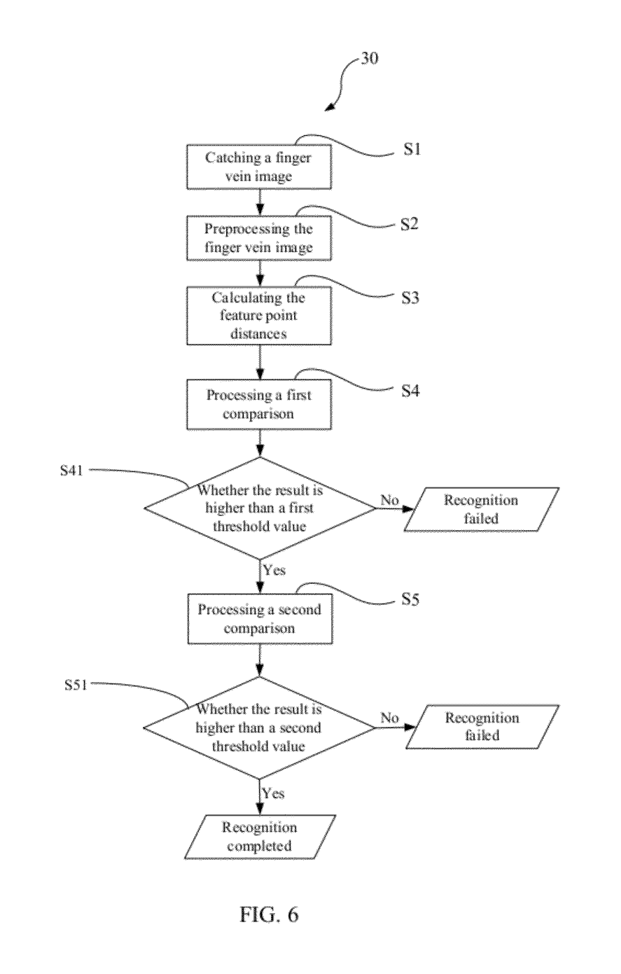

FIG. 6 is a flow diagram of a finger vein recognition method 30 of one embodiment of the invention. The present invention also provides a finger vein recognition method 30 comprising: (S1) catching a finger vein image; (S2) preprocessing the finger vein image; (S3) catching a plurality of feature points from the preprocessed finger vein image, and calculating a set of distances among the plurality of feature points; (S4) processing a first comparison for the set of distances with a feature database, and generating a compared result of feature point distances; (S5) catching a set of vein shape from the preprocessed finger vein image, processing a second comparison for the set of vein shape with the feature database, generating a compared result of shape similarity, combining the compared result of feature point distances and the compared result of shape similarity, and generating a recognized result of the finger vein.

Please refer to FIG. 2 and FIG. 3(A) to FIG. 3(E). Wherein (S2) of the finger vein recognition method 30 further comprises: (S21) processing the finger vein image for a Gaussian Smoothing (as shown in FIG. 3(A)); (S22) processing the finger vein image processed by the Gaussian Smoothing for a Convolution (as shown in FIG. 3(B)); (S23) processing the finger vein image processed by the Convolution for a Histogram Equalization (as shown in FIG. 3(C)); (S24) processing the finger vein image processed by the Histogram Equalization for a Binarization process (as shown in FIG. 3(D)); (S25) processing the finger vein image processed by the Binarization process for a thinning process (as shown in FIG. 3(E)).

In the practical application, (S3) of the finger vein recognition method 30 calculates the set of distances among the plurality of feature points by catching the plurality of feature points from the finger vein image processed by the thinning process (as shown in FIG. 3(E)). Wherein, the plurality of feature points can be a plurality of branch points or edge points of the finger vein image processed by the thinning process.

In the practical application, the finger vein recognition method 30 between (S4) and (S5) further comprises (S41): determining whether the compared result of feature point distances is higher than a first threshold value, if yes, further processing (S5); if no, outputting a result of recognition failure.

Furthermore, the set of vein shape (as shown in FIG. 4) of (S5) of the finger vein recognition method 30 is defined by subtracting the finger vein image processed by the Binarization process (as shown in FIG. 3(D)) from the finger vein image processed by the thinning process (as shown in FIG. 3(E)).

In the practical application, the finger vein recognition method 30 further comprises (S51): determining whether the recognized result of the finger vein is higher than a second threshold value, if yes, outputting a result of recognition completion; if no, outputting a result of recognition failure.

Compared to the prior art, the finger vein recognition method 30 utilizes the first comparison of (S4) for generating the compared result of feature point distances, and utilizes the second comparison of (S5) for generating the compared result of shape similarity, and combines the compared result of feature point distances and the compared result of shape similarity for generating the recognized result of the finger vein. Due to the finger vein recognition method 30 providing the advantage of a comparison of feature point distances for resisting a problem of the image rotation and the image translation, and utilizes a shape similarity of the finger vein for compensating a problem of the recognized effect relating to feature points caught for calculating the feature point distances. The finger vein recognition system can work effectively regardless of a low quality image or a low-cost equipment. Compared to the prior art, the finger vein recognition method 30 has the advantage of a higher recognition rate with a lower cost.

Although the present invention has been illustrated and described with reference to the preferred embodiment thereof, it should be understood that it is in no way limited to the details of such embodiment but is capable of numerous modifications within the scope of the appended claims.

What is claimed is:

1. A finger vein recognition method, comprising:
(S1) catching a finger vein image;
(S2) preprocessing the finger vein image;
(S3) catching a plurality of feature points from the preprocessed finger vein image, and calculating a set of distances among the plurality of feature points;
(S4) processing a first comparison for the set of distances with a feature database, and generating a compared result of feature point distances;
(S5) catching a set of vein shape from the preprocessed finger vein image, processing a second comparison for the set of vein shape with the feature database, generating a compared result of shape similarity, combining the compared result of feature point distances and the compared result of shape similarity, and generating a recognized result of the finger vein.

2. The finger vein recognition method of claim 1, wherein (S2) further comprises:
(S21) processing the finger vein image for a Gaussian Smoothing;
(S22) processing the finger vein image processed by the Gaussian Smoothing for a Convolution;
(S23) processing the finger vein image processed by the Convolution for a Histogram Equalization;
(S24) processing the finger vein image processed by the Histogram Equalization for a Binarization process; and
(S25) processing the finger vein image processed by the Binarization process for a thinning process.

3. The finger vein recognition method of claim 2, wherein (S3) is used to catch the plurality of feature points from the finger vein image processed by the thinning process, and calculates the set of distances among the plurality of feature points.

4. The finger vein recognition method of claim 3, wherein the plurality of feature points of (S3) can be a plurality of branch points or edge points of the finger vein image processed by the thinning process.

5. The finger vein recognition method of claim 2, wherein the set of vein shape of (S5) processes the second comparison and generates a compared result of shape similarity by subtracted the finger vein image processed by the Binarization process from the finger vein image processed by the thinning process.

6. A finger vein recognition system, comprising:
a image catching module for catching a finger vein image;
a image preprocess module, connected to the image catching module, for preprocessing the finger vein image in accordance with a predetermined procedure;
a feature points calculating module, connected to the image preprocess module, for catching a plurality of feature points from the preprocessed finger vein image, and calculating a set of distances among the plurality of feature points;
a feature database for pre-storing a set of feature data;
a first comparing module, connected to the feature points calculating module and the feature database, for comparing the set of distances and generating a compared result of feature point distances; and
a second comparing module, connected to the image preprocess module, the feature database and the first comparing module, for catching a set of vein shape and comparing the set of vein shape with the feature database for generating a compared result of shape similarity;
wherein the second comparing module combines the compared result of feature point distances and the compared result of shape similarity for generating a recognized result of the finger vein.

7. The finger vein recognition system of claim 6, wherein the predetermined procedure comprises:
(S21) processing the finger vein image for a Gaussian Smoothing;
(S22) processing the finger vein image processed by the Gaussian Smoothing for a Convolution;
(S23) processing the finger vein image processed by the Convolution for a Histogram Equalization;
(S24) processing the finger vein image processed by the Histogram Equalization for a Binarization process; and
(S25) processing the finger vein image processed by the Binarization process for a thinning process.

8. The finger vein recognition system of claim 7, wherein the feature points calculating module catches the plurality of feature points from the finger vein image processed by the thinning process, and calculates the set of distances among the plurality of feature points.

9. The finger vein recognition system of claim 7, wherein the set of vein shape generates a compared result of shape similarity by subtracted the finger vein image processed by the Binarization process from the finger vein image processed by the thinning process.

10. The finger vein recognition system of claim 8, wherein the plurality of feature points can be a plurality of branch points or edge points of the finger vein image processed by the thinning process.
